(19) United States
(12) Patent Application Publication
(10) Pub. No.: US 2024/0132335 A1
(43) Pub. Date: Apr. 25, 2024

(54) AERIAL LIFT SLOPE ADJUSTMENT SYSTEM

(71) Applicant: TIME MANUFACTURING COMPANY, Waco, TX (US)

(72) Inventor: James Randall Christian, Waco, TX (US)

(21) Appl. No.: 18/537,538

(22) Filed: Dec. 12, 2023

Related U.S. Application Data
(63) Continuation of application No. PCT/US22/34011, filed on Jun. 17, 2022.
(60) Provisional application No. 63/211,813, filed on Jun. 17, 2021.

(51) Int. Cl. B66F 17/00; B66F 11/04

(52) U.S. Cl. CPC B66F 17/006; B66F 11/044

(57) ABSTRACT

The present disclosure provides, inter alia, slope adjustment systems and methods for preventing aerial lifts from overturning during operation. Aerial lifts equipped with such systems are also provided.

### CROSS REFERENCE TO RELATED APPLICATIONS

The present application is a continuation of PCT international application no. PCT/US2022/034011, filed on Jun. 17, 2022, which claims benefit of U.S. Provisional Patent Application Ser. No. 63/211,813, filed on Jun. 17, 2021, which applications are incorporated by reference herein in their entireties.

### FIELD OF DISCLOSURE

The present disclosure relates generally to the field of aerial lifts, and in particular, to safe operation of such lifts. More specifically, the present disclosure provides, inter alia, slope adjustment systems and methods for preventing aerial lifts from overturning during operation.

### BACKGROUND OF THE DISCLOSURE

Aerial lifts are commonly used in the electric utility industry to facilitate work at an elevated position in several areas such as utility pole, telephone or power lines, street lights, building walls, etc. Aerial lifts are also widely used beyond the traditional electric utility industry, for example, in construction, emergency rescue, and movie industry, etc. Such aerial lifts typically boast work platforms (e.g., a workstation in the form of a bucket) coupled to wheeled vehicles through a multiple section-boom that is adapted to elevate and orient the aerial platform which carries the personnel who can perform the requisite work. The personnel also typically control the operation of the lift from the aerial platform or bucket through a control assembly that is coupled to the bucket and that includes several handles which can be used to manipulate the position and orientation of the bucket by controlling, among others, the multi-section boom.

There are many factors to consider for safe operations of aerial lifts including, e.g., the weather condition such as snow, ice and wind, the land condition such as solid or soft ground, sloped or level surface, etc. Among all possible hazards, overturn is one of the most severe accidents that may happen during aerial lift operation. Accordingly, aerial lifts should operate under constraints when working on sloped surfaces due to overturning stability, operational or structural limitations. However, there is currently no means to determine the exact constraints under different working conditions (i.e., the varied slope), which largely limits the safe applications of aerial lifts.

Accordingly, there is a need for a safe operation system that can provide guidance to aerial lifts working on sloped surfaces.

### SUMMARY OF THE DISCLOSURE

The present disclosure provides a slope operating system that can measure the slope angle of the ground surface on which an aerial lift is working and further limit the horizontal reach via the lower boom raise function if necessary.

Accordingly, one aspect of the present disclosure relates to a slope adjustment system for safe operation of an aerial lift, the aerial lift comprising a pedestal sitting on a movable chassis, a turret connected to the top of the pedestal and is able to rotate horizontally, a lower boom having a first end connected to the upper end of the turret and is able to rotate vertically, a knuckle connecting a second end of the lower boom with a first end of an extendable upper boom, and an aerial work platform connected to a second end of the upper boom, the slope adjustment system comprising: a plurality of sensors, comprising at least a slope sensor and a lower boom sensor, wherein the slope sensor is located on the bottom of the turret and measures in real-time a chassis angle that is the angle of the chassis relative to the horizontal surface, the lower boom sensor is located on the lower boom and measures in real-time a lower boom angle that is the angle of the lower boom relative to the chassis surface; a hydraulic enable valve, which is located in the turret and operably connected to a hydraulic control valve located inside the pedestal that can raise or lower the lower boom, wherein the lower boom can only be raised when the hydraulic enable valve is switched on; a control module, which receives real-time values of the chassis angle and the lower boom angle respectively measured by the slope senor and the lower boom sensor, and switches the hydraulic enable valve on or off based on the values received and an algorithm; and a boom rest, which is vertically mounted to the movable chassis and has a mechanical stow switch on its top, when the mechanical stow switch is off, the slope sensor stops measuring/updating the chassis angle.

Another aspect of the present disclosure is directed to a method for preventing an aerial lift from overturning during operation, the aerial lift comprising a pedestal sitting on a movable chassis, a turret connected to the top of the pedestal and is able to rotate horizontally, a lower boom having a first end connected to the upper end of the turret and is able to rotate vertically, a knuckle connecting a second end of the lower boom with a first end of an extendable upper boom, and an aerial work platform connected to a second end of the upper boom, the method comprising: a) measuring a chassis angle that is the angle of the chassis relative to the horizontal surface: i. if the chassis angle measured exceeds a maximum operating chassis angle, the lower boom is locked at its stowed position, or ii. if the chassis angle measured does not exceed the maximum operating chassis angle, determining a maximum operating lower boom angle based on the chassis angle measured; and b) measuring a lower boom angle that is the angle of the lower boom relative to the chassis surface: i. when the lower boom angle measured is less than the maximum operating lower boom angle, the raise function of the lower boom is enabled, and ii. when the lower boom angle measured reaches the maximum operating lower boom angle, the raise function of the lower boom is disabled.

The present disclosure also includes an aerial lift equipped with the slope adjustment system disclosed herein.

### BRIEF DESCRIPTION OF THE DRAWINGS

To facilitate further description of the embodiments of this disclosure, the following drawings are provided to illustrate and not to limit the scope of the disclosure.

FIG. 1 illustrates different working status of an aerial lift equipped with a slope adjustment system of the present disclosure. When working on a sloped surface (upper panel), the raise of the lower boom is limited, while on a horizontal surface (lower panel), it is able to raise to its full capacity.

FIG. 2 is a perspective view of an aerial lift equipped with a slope adjustment system, in accordance with certain embodiments of the present disclosure.

FIG. 3 is an enlarged view of a portion of the aerial lift of FIG. 2 including the boom rest with a mechanical stow switch, in accordance with certain embodiments of the present disclosure.

FIG. 4 is a perspective view of the slope adjustment system described in the present disclosure excluding the boom rest.

FIG. 5 is an enlarged view of a portion of the slope adjustment system of FIG. 4 including the control module, the hydraulic enable valve and the slope sensor.

### DETAILED DESCRIPTION OF THE DISCLOSURE

Novel systems for safe operation of aerial lifts and methods for preventing aerial lifts from overturning during operation are provided and described. Aerial lifts equipped with such systems or implementing such methods are also provided and described. Various embodiments and modifications are possible and fall within the scope of the present disclosure.

According to one aspect of the present disclosure, provided is a slope adjustment system for safe operation of an aerial lift, the aerial lift comprising a pedestal sitting on a movable chassis, a turret connected to the top of the pedestal and is able to rotate horizontally, a lower boom having a first end connected to the upper end of the turret and is able to rotate vertically, a knuckle connecting a second end of the lower boom with a first end of an extendable upper boom, and an aerial work platform connected to a second end of the upper boom, the slope adjustment system comprising: a plurality of sensors, comprising at least a slope sensor and a lower boom sensor, wherein the slope sensor is located on the bottom of the turret and measures in real-time a chassis angle that is the angle of the chassis relative to the horizontal surface, the lower boom sensor is located on the lower boom and measures in real-time a lower boom angle that is the angle of the lower boom relative to the chassis surface; a hydraulic enable valve, which is located in the turret and operably connected to a hydraulic control valve located inside the pedestal that can raise or lower the lower boom, wherein the lower boom can only be raised when the hydraulic enable valve is switched on; a control module, which receives real-time values of the chassis angle and the lower boom angle respectively measured by the slope senor and the lower boom sensor, and switches the hydraulic enable valve on or off based on the values received and an algorithm; and a boom rest, which is vertically mounted to the movable chassis and has a mechanical stow switch on its top, when the mechanical stow switch is off, the slope sensor stops measuring/updating the chassis angle.

As used herein, a “horizontal surface” refers to a flat surface at right angles to a plumb line. A horizontal surface herein can be used interchangeably with a “level surface” in normal operation of an aerial lift that is standard in the industry. As used herein, a “level surface” refers to a surface that at every point is perpendicular to a plumb line or the direction in which gravity acts, or parallel to the surface of still water. In some embodiments, the lower boom angle can be determined by measuring the lower boom's orientation relative to the horizontal surface.

In some embodiments, the algorithm employed by the control module is as follows: 1) if the value of the chassis angle received is equal to or greater than a maximum operating chassis angle, the hydraulic enable valve is switched off, the lower boom is locked at its stowed position, and the mechanical stow switch is on; or 2) if the value of the chassis angle received is less than the maximum operating chassis angle, the mechanical stow switch is off and the lower boom is released from its stowed position, the control module determines a maximum operating lower boom angle based on the value of the chassis angle received: a) when the value of the lower boom angle received is less than the maximum operating lower boom angle, the hydraulic enable valve is switched on, and b) when the value of the lower boom angle received reaches the maximum operating lower boom angle, the hydraulic enable valve is switched off.

The maximum operating chassis angle varies in different models of aerial lifts. In some embodiments, the maximum operating chassis angle can be in the range of 7 to 10 degrees. In some embodiments, the maximum operating chassis angle is 10 degrees.

In some embodiments, the lower boom can be fully extended (raised) having a maximum operating lower boom angle of 90 degrees when the value of the chassis angle received is equal to or less than a predetermined slope value. That is, an aerial lift working on a sloped surface with an angle that does not exceed a predetermined slope value is allowed to operate to its full envelope range as it operates on a horizontal surface. This predetermined slope value varies depending on aerial lift models. In some embodiments, the predetermined slope value is 5 degrees.

In some embodiments, the maximum operating chassis angle can exceed 10 degrees if the aerial life is equipped with a suitable set of stabilizers. As used herein, “stabilizers” or “outriggers” may refer to auxiliary parts (usually like legs) on a wheeled vehicle that are folded out when it needs stabilization, for example on a crane that lifts heavy loads, or aerial lifts as described in the present disclosure. In some embodiments, aerial lifts equipped with stabilizers or outriggers may increase the maximum operating chassis angle by up to 2 degrees.

For a specific aerial lift model, more factors may also practically affect the maximum operating lower boom angle. Accordingly, in some embodiments, the control module determines the maximum operating lower boom angle based on the value of the chassis angle received and additional parameters selected from the length of the upper boom, the weight of the upper boom, the load of the aerial work platform, and combinations thereof. Exemplary other parameters may include but not limited to the material of the lower boom and/or upper boom, the angle of the upper boom relative to the horizontal surface, the weight of the portion of the aerial lift that is below the pedestal, the weight distribution of the entire aerial lift, etc.

In some embodiments, the system further comprises a LED panel displaying a real-time status of the aerial lift. The status can be indicated in any suitable manner, e.g., color code, graphic and/or text format, or combinations thereof.

Another aspect of the present disclosure is directed to a method for preventing an aerial lift from overturning during operation, the aerial lift comprising a pedestal sitting on a movable chassis, a turret connected to the top of the pedestal and is able to rotate horizontally, a lower boom having a first end connected to the upper end of the turret and is able to rotate vertically, a knuckle connecting a second end of the lower boom with a first end of an extendable upper boom, and an aerial work platform connected to a second end of the upper boom, the method comprising: a) measuring a chassis angle that is the angle of the chassis relative to the horizontal surface: i. if the chassis angle measured exceeds a maximum operating chassis angle, the lower boom is locked at its stowed position, or ii. if the chassis angle measured does not exceed the maximum operating chassis angle, determining a maximum operating lower boom angle based on the chassis angle measured; and b) measuring a lower boom angle that is the angle of the lower boom relative to the chassis surface: i. when the lower boom angle measured is less than the maximum operating lower boom angle, the raise function of the lower boom is enabled, and ii. when the lower boom angle measured reaches the maximum operating lower boom angle, the raise function of the lower boom is disabled.

In some embodiments, the maximum operating chassis angle is in the range of 7 to 10 degrees. In some embodiments, the maximum operating chassis angle is 10 degrees.

In some embodiments, the maximum operating lower boom angle is 90 degrees when the chassis angle measured is equal to or less than a predetermined slope value. In some embodiments, the predetermined slope value is 5 degrees.

In some embodiments, the maximum operating chassis angle can exceed 10 degrees if the aerial life is equipped with a suitable set of stabilizers.

In some embodiments, the maximum operating lower boom angle is determined based on the chassis angle measured and additional parameters selected from the length of the upper boom, the weight of the upper boom, the load of the aerial work platform, and combinations thereof.

In some embodiments, the chassis angle and the lower boom angle are measured by a set of sensors. The sensors used herein are not limited to any specific type or model. Each senor may work alone or in combination with others.

In some embodiments, the lower boom angle is measured and monitored in real-time, to ensure the aerial life is operating in safe zone.

The present disclosure also includes an aerial lift equipped with the slope adjustment system disclosed herein.

The following discussion provides examples to further illustrate the present disclosure. These examples are illustrative only and are not intended to limit the scope of the disclosure in any way.

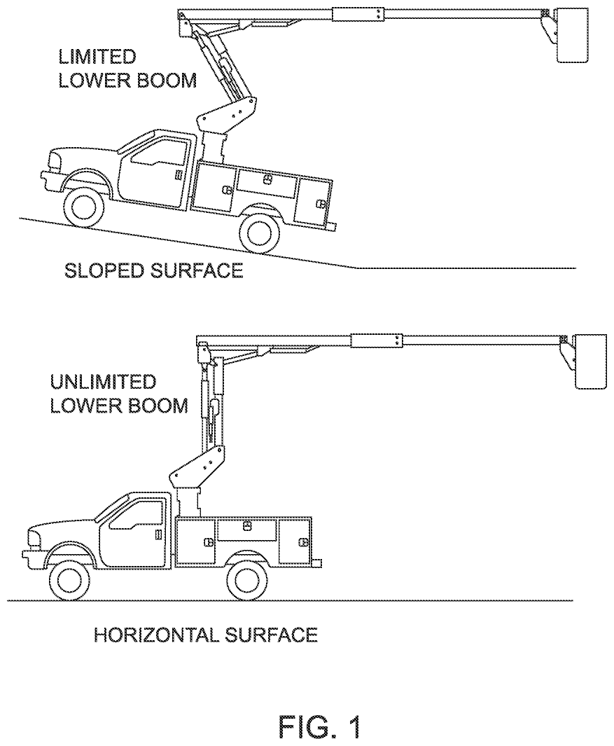

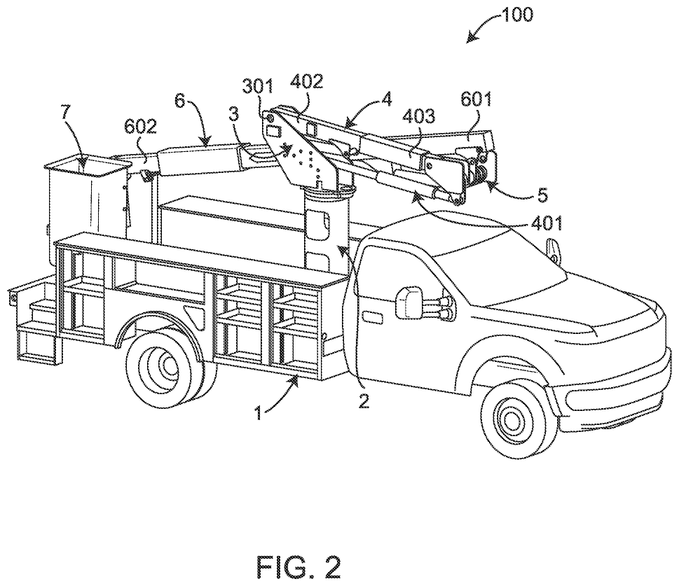

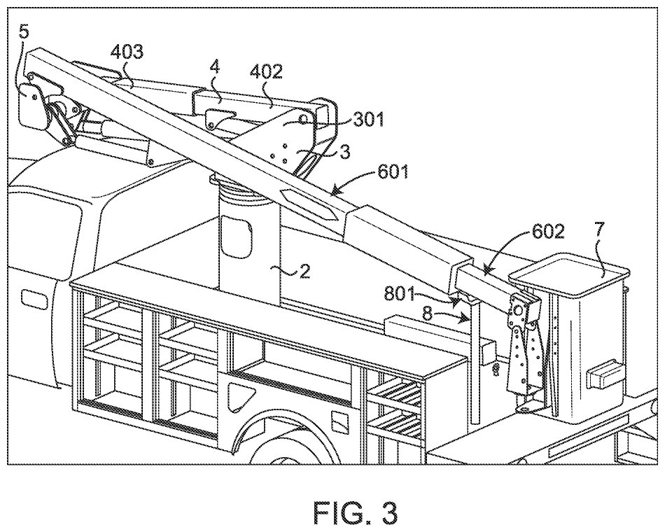

Referring to FIGS. 2 and 3, a typical aerial lift 100 comprises a movable chassis 1 (usually a motor vehicle such as a truck), a pedestal 2 sitting on the movable chassis 1, a turret 3 connected to the top of the pedestal 2 and is able to rotate horizontally, a lower boom 4 (often including a compensation link 401) having a first end 402 connected to the upper end 301 of the turret 3 and is able to rotate vertically, a knuckle 5 connecting a second end 403 of the lower boom 4 with a first end 601 of an extendable upper boom 6, and an aerial work platform 7 connected to a second end 602 of the upper boom 6. When the aerial lift 100 is operating on a horizontal surface or a sloped surface with an angle that is equal to or less than a certain value (that depends on specific aerial lift model, normally 5 degrees), the aerial lift is allowed to operate to its full envelope range, i.e., the lower boom 4 can raise to its full extension without potential risk of overturing due to the change of gravity center of the aerial lift as a whole. When the slope angle exceeds, e.g., 5 degrees above the horizontal surface, the structural, functional, and overturning stability limits may be exceeded when the aerial work platform is at a maximum horizontal position, that is, the risk of overturing increases significantly. A solution to this overturing risk is to limit the the lower boom maximum raised position when operating on a sloped surface, as shown in FIG. 1.

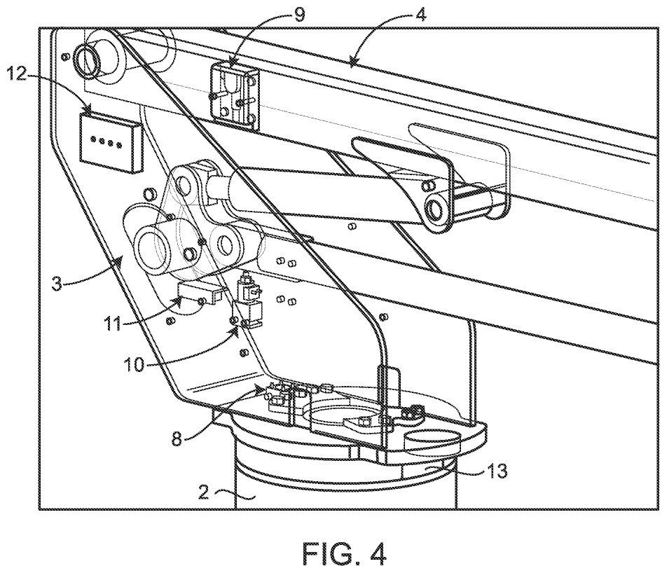

The present disclosure provides a slope adjustment system to implement this safety measure. Referring to FIG. 4, the system employs a set of angular sensors to assist determining the limitation on the lower boom raise function. Specifically, in certain embodiments of the present disclosure, a slope sensor 8 can be installed in the turret 3 and measure in real-time the angle between the chassis 1 and the horizontal surface (i.e., chassis angle). The chassis angle is equivalent to the slope angle of the sloped surface relative to the horizontal surface. The real-time value of the chassis angle is sent to a control module 11 located in the turret 3, which compares the chassis angle value to a predetermined maximum operating chassis angle. If the chassis angle received exceeds the maximum operating chassis angle, the control module 11 then disables the lower boom 4 raise (elevate) function by switching off a hydraulic enable valve 10 that is also located in the turret 3 and operably connected to a hydraulic control valve 13 located inside the pedestal 2 and the lower boom 4 is locked at its stowed position, under certain circurmstances, the upper boom 6 though may be free to operate. If the chassis angle received does not exceed the maximum operating chassis angle, a mechanical stow switch 801 on the top of a boom rest 8 is turned off (FIG. 3) and the slope sensor 8 stops measuring/updating the chassis angle, and both the lower boom 4 and the upper boom 6 are allowed to operate.

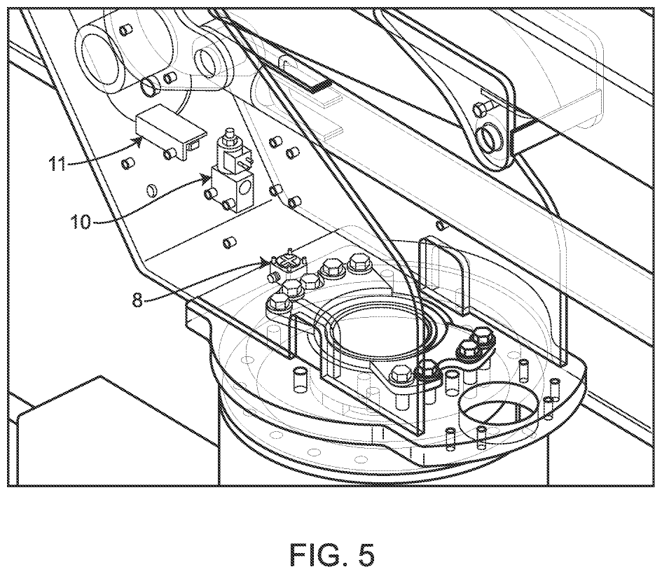

Referring back to FIG. 4, once the slope sensor 8 stops updating the chassis angle, the control module 11 then determines a maximum operating lower boom angle based on the value of the chassis angle last received. This creates a “safe zone” for the lower boom 4 to operate. A lower boom sensor 9 located on the lower boom 4 can measure in real-time a lower boom angle that is the angle of the lower boom relative to the chassis surface (or equivalently the surface on which the aerial lift is operating). The control module 11 receives this real-time lower boom angle and compares it to the prior-determined maximum operating lower boom angle, within which the lower boom 4 can freely operate. Once the lower boom angle reaches the maximum operating lower boom angle, the control module 11 switches off the hydraulic enable valve 10, thereby disables the raise function of the lower boom 4 and prevents it from further elevation. To facilitate the operation, in certain embodiments of the present disclosure, an LED panel 12 is also included in the slope adjustment system. The operating personnel can check the panel to monitor the status of the aerial lift and ensure the operation is within the safe zone. FIG. 5 provides an enlarged view focusing on the slope senor 8, the control module 11 and the hydraulic enable valve 10.

Although illustrative embodiments of the present disclosure have been described herein, it should be understood that the disclosure is not limited to those described, and that various other changes or modifications may be made by one skilled in the art. For example, it should be understood that various omissions and substitutions and changes in the form and details of the systems and methods described and illustrated may be made by those skilled in the art. Amongst other things, the steps in the methods may be carried out in different orders in many cases where such may be appropriate. Further variations, modifications, and implementations may occur to those of ordinary skill in the art without departing from the scope or spirit of the disclosure.

What is claimed is:

1. A slope adjustment system for safe operation of an aerial lift, the aerial lift comprising a pedestal sitting on a movable chassis, a turret connected to the top of the pedestal and is able to rotate horizontally, a lower boom having a first end connected to the upper end of the turret and is able to rotate vertically, a knuckle connecting a second end of the lower boom with a first end of an extendable upper boom, and an aerial work platform connected to a second end of the upper boom, the slope adjustment system comprising:
a plurality of sensors, comprising at least a slope sensor and a lower boom sensor, wherein the slope sensor is located on the bottom of the turret and measures in real-time a chassis angle that is the angle of the chassis relative to the horizontal surface, the lower boom sensor is located on the lower boom and measures in real-time a lower boom angle that is the angle of the lower boom relative to the chassis surface;
a hydraulic enable valve, which is located in the turret and operably connected to a hydraulic control valve located inside the pedestal that can raise or lower the lower boom, wherein the lower boom can only be raised when the hydraulic enable valve is switched on;
a control module, which receives real-time values of the chassis angle and the lower boom angle respectively measured by the slope senor and the lower boom sensor, and switches the hydraulic enable valve on or off based on the values received and an algorithm; and
a boom rest, which is vertically mounted to the movable chassis and has a mechanical stow switch on its top, when the mechanical stow switch is off, the slope sensor stops measuring/updating the chassis angle.

2. The system of claim 1, wherein the algorithm is as follows:
1) if the value of the chassis angle received is equal to or greater than a maximum operating chassis angle, the hydraulic enable valve is switched off, the lower boom is locked at its stowed position, and the mechanical stow switch is on; or
2) if the value of the chassis angle received is less than the maximum operating chassis angle, the mechanical stow switch is off and the lower boom is released from its stowed position, the control module determines a maximum operating lower boom angle based on the value of the chassis angle received:
a) when the value of the lower boom angle received is less than the maximum operating lower boom angle, the hydraulic enable valve is switched on, and
b) when the value of the lower boom angle received reaches the maximum operating lower boom angle, the hydraulic enable valve is switched off.

3. The system of claim 2, wherein the maximum operating chassis angle is in the range of 7 to 10 degrees.

4. The system of claim 2, wherein the maximum operating chassis angle is 10 degrees.

5. The system of claim 2, wherein the maximum operating lower boom angle is 90 degrees when the value of the chassis angle received is equal to or less than a predetermined slope value.

6. The system of claim 5, wherein the predetermined slope value is 5 degrees.

7. The system of claim 2, wherein the maximum operating chassis angle can exceed 10 degrees if the aerial life is equipped with a suitable set of stabilizers.

8. The system of claim 2, wherein the control module determines the maximum operating lower boom angle based on the value of the chassis angle received and additional parameters selected from the length of the upper boom, the weight of the upper boom, the load of the aerial work platform, and combinations thereof.

9. The system of claim 1, further comprising a LED panel displaying a real-time status of the aerial lift.

10. A method for preventing an aerial lift from overturning during operation, the aerial lift comprising a pedestal sitting on a movable chassis, a turret connected to the top of the pedestal and is able to rotate horizontally, a lower boom having a first end connected to the upper end of the turret and is able to rotate vertically, a knuckle connecting a second end of the lower boom with a first end of an extendable upper boom, and an aerial work platform connected to a second end of the upper boom, the method comprising:
a) measuring a chassis angle that is the angle of the chassis relative to the horizontal surface:
i. if the chassis angle measured exceeds a maximum operating chassis angle, the lower boom is locked at its stowed position, or
ii. if the chassis angle measured does not exceed the maximum operating chassis angle, determining a maximum operating lower boom angle based on the chassis angle measured; and
b) measuring a lower boom angle that is the angle of the lower boom relative to the chassis surface:
i. when the lower boom angle measured is less than the maximum operating lower boom angle, the raise function of the lower boom is enabled, and
ii. when the lower boom angle measured reaches the maximum operating lower boom angle, the raise function of the lower boom is disabled.

11. The method of claim 10, wherein the maximum operating chassis angle is in the range of 7 to 10 degrees.

12. The method of claim 10, wherein the maximum operating chassis angle is 10 degrees.

13. The method of claim 10, wherein the maximum operating lower boom angle is 90 degrees when the chassis angle measured is equal to or less than a predetermined slope value.

14. The method of claim 13, wherein the predetermined slope value is 5 degrees.

15. The method of claim 10, wherein the maximum operating chassis angle can exceed 10 degrees if the aerial life is equipped with a suitable set of stabilizers.

16. The method of claim 10, wherein the maximum operating lower boom angle is determined based on the chassis angle measured and additional parameters selected from the length of the upper boom, the weight of the upper boom, the load of the aerial work platform, and combinations thereof.

17. The method of claim 10, wherein the chassis angle and the lower boom angle are measured by a set of sensors.

18. The method of claim 10, wherein the lower boom angle is measured and monitored in real-time.

19. An aerial lift equipped with the slope adjustment system according to any one of claims 1-9.
